(19) United States
(12) Patent Application Publication
(10) Pub. No.: US 2011/0214862 A1
(43) Pub. Date: Sep. 8, 2011

(54) PARTICULATE BRIDGING AGENTS USED FOR FORMING AND BREAKING FILTERCAKES ON WELLBORES

(75) Inventors: Robert L. Horton, Sugar Land, TX (US); Bethicia B. Prasek, The Woodlands, TX (US)

(73) Assignee: M-I L.L.C., Houston, TX (US)

(21) Appl. No.: 13/128,117

(22) PCT Filed: Nov. 12, 2009
(86) PCT No.: PCT/US09/64080

§ 371 Date: May 6, 2011

(51) Int. Cl. E21B 43/26; C09K 8/76

(52) U.S. Cl. 166/283; 507/219; 507/269; 507/272; 507/271; 507/201

(57) ABSTRACT

A method of preventing fluid loss to a wellbore that includes pumping a wellbore fluid into the wellbore through a subterranean formation, the wellbore fluid comprising: a base fluid; and a plurality of particulate bridging agents comprising a solid breaking agent encapsulated by one of an inorganic solid material and an oil-soluble resin; and allowing some filtration of the wellbore fluid into the subterranean formation to produce a filter cake comprising the particulate bridging agents is disclosed.

### BACKGROUND OF INVENTION

1. Field of the Invention

The present disclosure relates generally to a particulate bridging agents used in wellbore fluids for drilling a wellbore. More specifically, the present disclosure relates to particulate bridging agents used for forming and breaking filtercakes on wellbore walls.

2. Background Art

Hydrocarbons (oil, natural gas, etc.) are typically obtained from a subterranean geologic formation (i.e., a “reservoir”) by drilling a well that penetrates the hydrocarbon-bearing formation. In order for hydrocarbons to be “produced,” that is, travel from the formation to the wellbore (and ultimately to the surface), there must be a sufficiently unimpeded flowpath from the formation into the wellbore. One key parameter that influences the rate of production is the permeability of the formation along the flowpath that the hydrocarbon must travel to reach the wellbore. Sometimes, the formation rock has a naturally low permeability; other times, the permeability is reduced during, for instance, drilling the well.

During the drilling of a wellbore, a variety of so-called wellbore fluids are typically used in the well for a variety of functions. When a well is drilled, a drilling fluid is often circulated into the hole to contact the region of a drill bit, for a number of reasons such as: to cool the drill bit, to carry the rock cuttings away from the point of drilling, and to maintain a hydrostatic pressure on the formation wall to prevent production during drilling. The drilling fluids may be circulated through a drill pipe and drill bit into the wellbore, and then may subsequently flow upward through wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

During well operations, the drilling fluid can be lost by leaking into the formation. To prevent this, the drilling fluid is often intentionally modified so that a small amount leaks off and forms a coating on the wellbore surface (often referred to as a “filtercake”) and thereby protecting the formation. Filtercakes are formed when particles suspended in a wellbore fluid coat and plug the pores in the subterranean formation such that the filtercake prevents or reduces both the loss of fluids into the formation and the influx of fluids present in the formation. A number of ways of forming filtercakes are known in the art, including the use of bridging particles, cuttings created by the drilling process, polymeric additives, and precipitates. Fluid loss pills may also be used where a viscous pill comprising a polymer may be used to reduce the rate of loss of a wellbore fluid to the formation through its viscosity

Upon completion of drilling, the filtercake and/or fluid loss pill may stabilize the wellbore during subsequent completion operations such as placement of a gravel pack in the wellbore. Additionally, during completion operations, when fluid loss is suspected, a fluid loss pill of polymers may be “spotted” or placed in the wellbore. Other completion fluids may be injected behind the fluid loss pill into a position within the wellbore which is immediately above a portion of the formation where fluid loss is suspected. Injection of fluids into the wellbore is then stopped, and fluid loss will then move the pill toward the fluid loss location to coat the formation and prevent or reduce future fluid loss.

After any completion operations have been accomplished, the filtercake (formed during drilling and/or completion) on the sidewalls of the wellbore must typically be removed, because remaining residue of the filtercake may negatively impact production. That is, although filtercake formation and use of fluid loss pills are essential to drilling and completion operations, the barriers may be a significant impediment to the production of hydrocarbons or other fluids from the well, if, for example, the rock formation is still plugged by the barrier. Because the filtercake is compacted onto the rock face, it often adheres strongly to the formation and may not be readily or completely flushed out of the formation by another fluid degrading the filtercake on the wall.

Filter cakes and fluid loss pills are typically formed from fluids that contain polymers such as polysaccharide polymers that may be degradable by a breaker, including starch derivatives, cellulose derivatives and biopolymers. Specifically, such polymers may include hydroxypropyl starch, hydroxyethyl starch, carboxymethyl starch, carboxymethyl cellulose, hydroxyethyl cellulose, hydroxypropyl cellulose, methyl cellulose, dihydroxypropyl cellulose, xanthan gum, gellan gum, wellan gum, and scleroglucan gum, in addition to the derivatives thereof, and crosslinked derivatives thereof. Further, one of ordinary skill in the art would appreciate that such list is not exhaustive and that other polymers may be present in the filter cakes/pills to be degraded.

Further, various types of solids may optionally be suspended in wellbore fluids to bridge or block the pores of a subterranean formation (or holes of a screen) in a filter cake. Such solids include those described in U.S. Pat. Nos. 4,561,985, 3,872,018, and 3,785,438, which are herein incorporated by reference in their entirety. Of particular interest are those solids soluble in acid solutions. Representative acid soluble bridging solids include magnesium and calcium carbonate, limestone, marble, dolomite, iron carbonate, iron oxide, and magnesium oxide. However, other solids may be used without departing from the scope of the present disclosure. Other representative solids include water-soluble and oil-soluble solids as described in U.S. Pat. No. 5,783,527.

Drilling fluids or muds typically include a base fluid (water, diesel or mineral oil, or a synthetic compound), weighting agents (most frequently barium sulfate or barite is used), bentonite clay (or other viscosifiers) to help viscosify a fluid to suspend and remove cuttings from the well, bridging agents to bridge pores of the formation upon formation of the filter cake, fluid loss additives (frequently natural or synthetic polymers) to provide fluid loss control to the filtercake, and thinners such as lignosulfonates and lignites to keep the mud in a fluid state. Fluid loss pills may similarly include a base fluid, bridging agents, polymeric additives or other viscosifiers, etc. Meantime, breaker fluids, which are used for flushing the filtercake after the completion of the drilling, typically include a base fluid and various oxidants such as persulfates, peroxides, or hydroperoxides, enzymes, or acid washes to break the filtercake formed on the wall.

However, there exists a continuing need for further developments in wellbore fluids used for forming and breaking the filtercake to maximize filtercake removal.

### SUMMARY OF INVENTION

In one aspect, embodiments disclosed herein relate to a method of preventing fluid loss to a wellbore that includes pumping a wellbore fluid into the wellbore through a subterranean formation, the wellbore fluid comprising: a base fluid; and a plurality of particulate bridging agents comprising a solid breaking agent encapsulated by one of an inorganic solid material and an oil-soluble resin; and allowing some filtration of the wellbore fluid into the subterranean formation to produce a filter cake comprising the particulate bridging agents.

In another aspect, embodiments disclosed herein relate to a method of breaking a filtercake that includes releasing a solid breaking agent encapsulated by one of a solid inorganic material and an oil-soluble resin from the encapsulation, wherein the encapsulated solid breaking agent is incorporated in the filtercake; and allowing the released breaking agent to degrade at least a portion of the filtercake.

In yet another aspect, embodiments disclosed herein relate to a wellbore fluid that includes a base fluid; and particulate bridging agents comprising a solid breaking agent encapsulated by one of a solid inorganic material and an oil-soluble resin.

In yet another aspect, embodiments disclosed herein relate to a particulate bridging agent used for forming and breaking a filtercake on a wellbore wall that includes a solid breaking agent encapsulated by one of a solid inorganic material and an oil-soluble resin.

In yet another aspect, embodiments disclosed herein relate to a method of forming a particle that includes providing a solid breaking agent; and encapsulating the solid breaking agent with one of a solid inorganic material and an oil-soluble resin.

Other aspects and advantages of the invention will be apparent from the following description and the appended claims.

### DETAILED DESCRIPTION

Embodiments of the present disclosure relate generally to particulate bridging agents used in wellbore fluids for drilling/completing a wellbore. More specifically, the present disclosure relates to particulate bridging agents that form a part of a filtercake (either during drilling or through use of a viscosified fluid loss pill) on wellbore walls as well as the subsequent breaking of the filter cake prior to production of the well. Other embodiments of the disclosure relate to wellbore fluids containing such particulate bridging agents as well as to methods for manufacturing such particulate bridging agents. Even further, yet other embodiments disclosed herein relate to a drilling or completion process whereby a wellbore fluid containing particulate bridging agents is circulated in a wellbore; and some filtration of the fluid occurs, allowing the particulate bridging agents to bridge pores of a wellbore wall such that a filtercake is efficiently formed on the wall. After completion of the drilling/completion operation, breaking of the filtercake may be internally aided/broken by the particulate bridging agents forming a part of the filtercake.

During drilling of a wellbore, the top section or “top-hole” wellbore is typically drilled using a non-reservoir drilling fluid, whereas the wellbore beyond the top-hole (penetrating into the petroliferous reservoir) is drilled with a reservoir-friendly drilling fluid (reservoir drilling fluid or RDF). Non-reservoir drilling fluids are formulated with less concern as to how the filtrate may interact adversely with the permeability properties of the non-reservoir rock whereas a reservoir drilling fluid is best designed to be much more benign towards the permeability properties of the rock comprising the petroliferous formation. After completion of the drilling operation, breaking of the filtercake is typically unnecessary in the top-hole section of the wellbore whereas in the wellbore beyond the top-hole that penetrates into the petroliferous reservoir, breaking of the filtercake may be internally aided/broken by the particulate bridging agents forming a part of the filtercake.

Thus, while some filter cakes are formed during the drilling stage to limit losses from the well bore and protect the formation from possible damage by fluids and solids within the well bore, others are formed from spotted fluid loss pills to similarly reduce or prevent the influx and efflux of fluids across the formation walls. In addition to possessing bridging agents which may block pores of a formation or holes in a screen, fluid loss pills may also prevent such fluid movement by the pills' viscosity. Further, in gravel packing, it may also be desirable to deposit a thin filter cake on the inside surface of a gravel pack screen to effectively block fluid from invading the formation. Thus, any reference to filtercakes also refers to or includes residual fluid loss pills which may be spotted or otherwise placed into a well during any wellbore operation (primarily to reduce or minimize fluid loss during completion operations).

In the following description, numerous details are set forth to provide an understanding of the present disclosure. However, it will be understood by those skilled in the art that the present invention may be practiced without these details and that numerous variations or modifications from the described embodiments may be possible.

Particulate Bridging Agent

As briefly mentioned above, the particulate bridging agents of the present disclosure may be used for both forming and breaking a filtercake on a wellbore wall in the reservoir section of the wellbore beyond the top-hole section of the well, or a filtercake which results from a spotted fluid loss pill. To achieve ability for dual functionality (bridging and filtercake breaking), the particulate bridging agents may contain a solid breaking agent encapsulated by an inorganic solid material or an oil-soluble resin.

Thus, the outer encapsulation layer of the inorganic solid material or oil-soluble resin provides the bridging functionality to the additive. Such encapsulation materials may include those types of materials conventionally used as bridging agents which are soluble by acid washes, such as, for example, with 5% hydrochloric acid or 10% citric acid solutions, or soluble by water or oil (when used in an oil- or water-based fluid, respectively). Alternatively, such encapsulation materials may be dissolved by the application of oxidants such as, for example, persulfates, peroxides, or hydroperoxides, enzymes, chelants, or acid treatments, such as, for example, with solid sulfamic, glycolic, lactic, polyglycolic, or polylactic acids. As yet another alternative, such encapsulation materials may be dissolved by the application of scale removal agents such as, for example, alkali metal formates or alkali metal salts of diethylenetriaminepentaacetic acid or other chelating agents.

For example, suitable inorganic solid materials for forming encapsulation material may include calcium carbonates, magnesium carbonates, zinc oxides, magnesium oxide, zinc carbonates, calcium sulfates, strontium sulfates, barium sulfates, calcium chloride, sodium chloride, and the like, or combinations thereof. Selection between such materials may depend, for example, on the type of fluid in which the bridging agents are being used, e.g., calcium chloride and sodium chloride, which are water-soluble, may be used in an oil-based fluid. However, one skilled in the art would appreciate that no limitation on the types of materials that may be used exits. Rather, any types of material which may conventionally be used as a bridging agent in the art may be used as the encapsulation material.

Additionally, suitable organic solid materials for forming the encapsulation material may include any organic material amenable to dissolution through the application of hydrocarbons, acids or acid solutions or enzyme solutions. Suitable organic solid materials may include such things as, for example, starches or oil-soluble resins. Examples of such oil-soluble resins may include styrene-isoprene copolymers, hydrogenated styrene-isoprene block copolymers, styrene ethylene/propylene block copolymers, styrene isobutylene copolymers, styrene butadiene copolymers, polybutylene and polystyrene, polyethylene-propylene copolymers, include copolymers and block copolymers such as poly(styrene-co-isoprene), hydrogenated block-copoly(styrene/isoprene), block-copoly(styrene/ethylene/propylene), poly(styrene-co-isobutylene), copolymer(styrene-co-butadiene), polybutylene, polystyrene, copolymer(polyethylene-co-propylene), poly-indene, poly-coumarone (poly-2,3-benzofuran) poly-coumarone-indene, poly-terpenes, and combinations of two or more thereof. When using an oil-soluble resin as the encapsulating layer, dissolution of the oil-soluble resin may occur by hydrocarbons flowing out from the petroliferous formation, or by spotting a hydrocarbon fluid.

Additionally, it is also within the scope of the present disclosure that two or more encapsulating layers (of the same or differing materials). In such a case, depending on the types/combination of materials selected, it may be necessary to apply two or more corresponding encapsulant release triggers to release the encapsulated breaker. Such triggers may include any of water, acidic solution, or oleaginous fluids, as well as enzymes, chelants, oxidants, scale removal or scale dissolving agents, etc.

The breaking functionality (of other filter cake components and the filter cake generally) may be achieved by providing a solid breaking agent as the core of the particulate to be encapsulated by the organic or inorganic material as described above. A variety of breaking agents are used in the art, and in accordance with the present disclosure, any such types of materials may be encapsulated, forming the core of the particulate bridging agents. Thus, exemplary types of breaking agents which may be used as the core of the particulate bridging agent may include various inorganic or organic acids, chelants, scale removal or scale dissolving agents, solvents, surfactants, thinning agents, oxidants, and enzymes. Moreover, while the present disclosure relates to “solid” breaking agents, it is explicitly within the scope of the present disclosure that such “solid” state may be provided in the form of a solid support onto which a liquid breaker material may be adsorbed or absorbed. Such solid support (alone) may or may not possess breaker functionality.

Suitable organic acids that may be used as the solid breaking agents may include citric acid, salicylic acid, glycolic acid, malic acid, maleic acid, fumaric acid, and homo- or copolymers of lactic acid and glycolic acid as well as compounds containing hydroxy, phenoxy, carboxylic, hydroxycarboxylic or phenoxycarboxylic moieties. In addition to organic acids, hydrolysable esters which may hydrolyze to release an organic (or inorganic) acid may also be used, including, for example, hydrolyzable esters of a C₁ to C₆ carboxylic acid and/or a C₂ to C₃₀ mono- or poly-alcohol, including alkyl orthoesters. If, for example, a particular hydrolyzable ester of a C₁ to C₆ carboxylic acid and/or a C₂ to C₃₀ poly alcohol were found to be above its melting point at or around the temperature desired for applying the same, then it would be readily understood by one skilled in the art that a longer chain carboxylic acid and/or a longer chain mono- or poly-alcohol or other polymer, such as, for example, the ethylene glycol adduct of polymaleic anhydride, could be found that would be a solid in this same temperature range. In addition to these hydrolysable carboxylic esters, hydrolysable phosphonic or sulfonic esters could be utilized, such as, for example, R₁H₂PO₃, R₁R₂HPO₃, R₁R₂R₃PO₃, R₁HSO₃, R₁R₂SO₃, R₁H₂PO₄, R₁R₂HPO₄, R₁R₂R₃PO₄, R₁HSO₄, or R₁R₂SO₄, where R₁, R₂, and R₃ are C₂ to C₃₀ alkyl-, aryl-, arylalkyl-, or alkylaryl-groups. In addition to the said organic acids and hydrolysable esters, hydrolysable anhydrides, amides, and nitriles of said carboxylic moieties or carboxylic esters and be used.

Suitable inorganic acids that may be used as the solid breaking agents may include sulfurous, sulfuric, thiosulfuric, trithionic, polythionic, sulfamic, phenylsulfuric, phenylsulfonic, benzylsulfuric, benzylsulfonic, phosphorous, phosphoric, thiophosphoric, phosphamic, phenylphosphoric, phenylphosphonic, benzylphosphoric, benzylphosphonic acids and the mono-acid salts (if any) thereof and the like.

Other organic acids which may also be described as chelating agents that may be used as the solid breaking agents may include, for example, ethylenediaminetetraacetic acid (EDTA), diethylenetriaminepentaacetic acid (DTPA), nitrilotriacetic acid (NTA), ethylene glycol-bis(2-aminoethyl)-N,N,N′,N-tetraacetic acid (EGTA), 1,2-bis(o-aminophenoxy)ethane-N,N,N′,N′-tetraaceticacid (BAPTA), cyclohexanediaminetetra-acetic acid (CDTA), triethylenetetraaminehexaacetic acid (TTHA), N-(2-hydroxyethyl)ethylenediamine-N,N′,N′-triacetic acid (HEDTA), glutamic-N,N-diacetic acid (GLDA), ethylene-diamine tetra-methylene sulfonic acid (EDTMS), diethylene-triamine penta-methylene sulfonic acid (DETPMS), amino tri-methylene sulfonic acid (ATMS), ethylene-diamine tetra-methylene phosphonic acid (EDTMP), diethylene-triamine penta-methylene phosphonic acid (DETPMP), amino tri-methylene phosphonic acid (ATMP), cyclohexylene dinitrilo tetraacetic acid (CDTA), [ethylenebis (oxyethylenenitrilo)]tetraacetic acid (EGTA, also known as ethyleneglycol-bis-(beta-aminoethyl ether) N,N′-tetraacetic acid), [(carboxymethyl)imino]-bis(ethylenenitrilo)]-tetra-acetic acid (DTPA, also known as diethylenetriaminepenta-acetic acid), hydroxyethylethylene diaminetriacetic acid (HEDTA), salts thereof, and mixtures thereof. Such salts may include potassium or sodium salts thereof, for example. However, this list is not intended to have any limitation on the chelating agents (or salt types) suitable for use in the embodiments disclosed herein. In fact, some of the salts may be fully neutralized and hence not acidic at all. One of ordinary skill in the art would recognize that selection of the chelating agent may depend on availability and cost of the materials in dry powder form such that the materials may be encapsulated with the inorganic material types of additives likely present in the filtercake that require breaking.

Suitable oxidizing agents may include peroxysulfuric acid; persulfates such as ammonium persulfate, sodium persulfate, and potassium persulfate; peroxides such as hydrogen peroxide, t-butylhydroperoxide, methyl ethyl ketone peroxide, cumene hydroperoxide, benzoyl peroxide, acetone peroxide, methyl ethyl ketone peroxide, 2,2-bis(tert-butylperoxy)butane, pentane hydroperoxide, bis[1-(tert-butylperoxy)-1-methylethyl]benzene, 2,5-bis(tert-butylperoxy)-2,5-dimethylhexane, tert-butyl peroxide, tert-butyl peroxybenzoate, lauroyl peroxide, and dicumyl peroxide; bromates such as sodium bromate and potassium bromate; iodates such as sodium iodate and potassium iodate; periodates such as sodium periodate and potassium periodate; permanganates such as potassium permanganate; chlorites such as sodium chlorite; hypochlorites such as sodium hypochlorite; peresters such as tert-butyl peracetate; peracids such as peracetic acid; azo compounds such as azobisisobutyronitrile (AIBN), 2,2′-azobis(2-methylpropionitrile), 1,1′-azobis (cyclohexanecarbonitrile), 4,4′-azobis(4-cyanovaleric acid), or their combinations. However, this list is not intended to have any limitation on the oxidizing agents suitable for use in the embodiments disclosed herein. One of ordinary skill in the art would recognize that selection of the oxidizing agent may depend on downhole condition. Such oxidizing agents may be used as solids or liquid states that have been adsorbed onto treated supports.

Also, enzymes may be applied as the solid breaking agent. A wide variety of enzymes have been identified and separately classified according to their characteristics. A detailed description and classification of known enzymes is provided in the reference entitled ENZYME NOMENCLATURE (1984): RECOMMENDATIONS OF THE NOMENCLATURE COMMITTEE OF THE INTERNATIONAL UNION OF BIOCHEMISTRY ON THE NOMENCLATURE AND CLASSIFICATION OF ENZYME-CATALYSED REACTIONS (Academic Press 1984) [hereinafter referred to as “Enzyme Nomenclature (1984)”], the disclosure of which is fully incorporated by reference herein. According to Enzyme Nomenclature (1984), enzymes can be divided into six classes, namely (1) Oxidoreductases, (2) Transferases, (3) Hydrolases, (4) Lyases, (5) Isomerases, and (6) Ligases. Each class is further divided into subclasses by action, etc. Although each class may include one or more enzymes that will degrade one or more polymeric additives present in a wellbore fluid (and thus filter cake), the classes of enzymes in accordance with Enzyme Nomenclature (1984) most useful in the methods of the present invention are (3) Hydrolases, (4) Lyases, (2) Transferases, and (1) Oxidoreductases. Of these, enzymes of classes (3) and (4) may be the most applicable to the present disclosure.

Examples of enzymes within classes (1)-(4) according to Enzyme Nomenclature (1984) for use in accordance with the methods of the present disclosure are described in Table I below:

TABLE I
Class (3) Hydrolases (enzymes functioning to catalyze the hydrolytic
cleavage of various bonds including the bonds C—O, C—N, and C—C)

3.1 - Enzymes Acting on Ester Bonds

3.1.3 - Phosphoric monoester hydrolases

3.2 - Glycosidases

3.2.1.1 - alpha-Amylase
3.2.1.2 - beta-Amylase
3.2.1.3 - Glucan 1,4-alpha-glucosidase
3.2.1.4 - Cellulase
3.2.1.11 - Dextranase
3.2.1.20 - alpha-Glucosidase
3.2.1.22 - alpha-Galactosidase
3.2.1.25 - beta-Mannosidase
3.2.1.48 - Sucrase
3.2.1.60 - Glucan 1,4-alpha-maltotetraohydrolase
3.2.1.70 - Glucan 1,6-alpha-glucosidase

3.4 - Enzymes Acting on Peptide Bonds (peptide hydrolases)

3.4.22 - Cysteine proteinases
3.4.22.2 - Papain
3.4.22.3 - Fecin
3.4.22.4 - Bromelin

Class (4) Lyases (enzymes cleaving C—C, C—O, C—N and
other bonds by means other than hydrolysis or oxidation)

4.1 - Carbon--carbon lyases
4.2 - Carbon--oxygen lyases
4.3 - Carbon--nitrogen lyases

Class (2) Transferases (enzymes transferring a group, for example, a
methyl group or a glyccosyl group, from one compound (donor) to another
compound (acceptor)

2.1 - Transferring one-carbon groups

2.1.1 - Methyltransferases

2.4 - Glycosyltransferases

2.4.1.1 - Phosphorylase

Class (1) Oxidoreductases (enzymes catalyzing oxidoreductions)

1.1 - Acting on the CH—OH group of donors

1.1.1.47 - glucose dehyogenase

In particular embodiments, endo-amylase, exo-amylase, isomylase, glucosidase, amylo-glucosidase, malto-hydrolase, maltosidase, isomalto-hydro-lase or malto-hexaosidase may be used in the breaker fluids of the present disclosure. Such enzymes may be present in an amount ranging from 1 to 10 weight percent of the fluid. Further, one skilled in the art would appreciate that selection among the various breaking agents for a particular filter cake clean up application may depend on various factors such as the type of polymeric additive used in the wellbore fluid, for example, carboxymethylcellulose, hydroxyethylcellulose, guar, xanthan, glucans and starch, the temperature of the wellbore, the pH selected for chelating strength, etc.

Scale dissolving agents that may be used as the solid breaking agents may include, for example, alkali metal formates or alkali metal salts of diethylenetriaminepentaacetic acid. These scale dissolving agents may be coated with suitable encapsulation materials. The encapsulated scale dissolving agents may subsequently be released by the application of a suitable release mechanism whereupon the scale dissolving agents may become active as breaking agents.

Solvents that may be used as breaking agents may include, for example, diesel, EGMBE, d-limonene, alcohols, mineral oil, terpenes, xylene. These solvents may be coated with suitable encapsulation materials. The encapsulated solvents may subsequently be released by the application of a suitable release mechanism whereupon the solvents may become active as breaking agents.

Surfactants that may be used as breaking agents may include, for example ethoxylated amines, sorbitan esters or stearyl esters, or calcium dodecylbenzenefulfonate. One example of a commercial surfactant includes SAFE-SURF O. These surfactants may be coated with suitable encapsulation materials. The encapsulated surfactants may subsequently be released by the application of a suitable release mechanism whereupon the surfactants may become active as breaking agents.

Thinning agents that may be used as breaking agents may include, for example lignosulfonates, lignitic materials, modified lignosulfonates, polyphosphates, tannins, and low molecular weight polyacrylates. These thinning agents may be coated with suitable encapsulation materials. The encapsulated thinning agents may subsequently be released by the application of a suitable release mechanism whereupon the thinning agents may become active as breaking agents

Manufacturing Process of Particulate Bridging Agents

Various manufacturing methods may be applied to producing the particulate agents. These methods may include physical or chemical processes. The methods may include a process of providing a solid breaking agent; and a process of encapsulating the solid breaking agent with an inorganic solid material or oil-soluble resin. In one embodiment of the encapsulation process, for example, a fluidized bed technique may be applied, in which particle-like breaker agents are coated by the inorganic solid material or oil-soluble resin while suspended in an upward-moving air or dry nitrogen stream. Further, in other embodiments, a spray drying technique may be applied, in which the encapsulating materials are sprayed onto the particle-like breaking agents, thereby forming the coating.

In one example, a concentrated slurry of fine calcium carbonate particles in a suitable liquid vehicle may be sprayed onto the surfaces of the breaker particles in the fluidized bed dryer. The slurries may be formulated from fresh water with relatively small amounts of polyvinyl alcohol or xanthan gum to impart some solids-suspending character to the fresh water, to which then fine calcium carbonate may be added. Alternatively, the slurries may also be formulated with calcium bicarbonate contained therein so that when the slurry is sprayed onto the breaker particles in the drying apparatus, the fine calcium carbonate not only coats the breaker particles by adsorption, but the calcium bicarbonate also decomposes in the process of drying in such a way that it precipitates additional calcium carbonate onto the exposed surfaces such that this additional calcium carbonate may serve as an adhesive material to “glue” the fine calcium carbonate particles in the slurry onto the surfaces of the breaker particles.

In another example, a mixture of a solid breaking agent or a liquid breaking agent suitably disposed upon a solid substrate and an inorganic solid material or oil-soluble resin are pelletized together. Subsequently the pellets are classified mechanically and a suitable fraction of the pellets having a desired particle size distribution are selected for use as part of the bridging agent additives in formulating a reservoir drilling fluid. Some of the breaking agent in each pellet will be disposed on the outside of the pellet and will be active almost immediately; however, another portion of the breaking agent in each pellet will be disposed on the inside of the pellet and will be initially inactive. This other portion of the breaking agent will, in effect, be encapsulated within the pellets. Subsequently, the encapsulated breaking agents may be released by the application of a suitable release mechanism whereupon said breaking agents may become active.

Use in Drilling Fluid

In some embodiments of the present disclosure, the above explained particulate agents may be used in any wellbore fluid such as drilling, cementing, completion, packing, work-over (repairing), stimulation, well killing, spacer fluids, etc. Such alternative uses, as well as other uses, of the present fluid should be apparent to one of skill in the art given the present disclosure. The wellbore fluid may be a water-based fluid, or an oil-based fluid, including wholly oil-based fluids as well as invert or direct emulsions.

Water-based wellbore fluids may have an aqueous fluid as the base liquid and in which the particulate bridge agents of the present disclosure may be used. The aqueous fluid may include at least one of fresh water, sea water, brine, mixtures of water and water-soluble organic compounds and mixtures thereof. For example, the aqueous fluid may be formulated with mixtures of desired salts in fresh water. Such salts may include, but are not limited to alkali metal halides, hydroxides, or carboxylates, for example. In various embodiments of the drilling fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, lithium, and salts of chlorides, bromides, carbonates, iodides, chlorates, bromates, formates, nitrates, oxides, sulfates, silicates, phosphates, and fluorides. Salts that may be incorporated in brine include any one or more of those present in natural seawater or any other organic or inorganic dissolved salts. Additionally, brines that may be used in the drilling fluids disclosed herein may be natural or synthetic, with synthetic brines tending to be much simpler in constitution. In one embodiment, the density of the drilling fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

The invert emulsion wellbore fluids may include an oleaginous continuous phase, a non-oleaginous discontinuous phase, and the particulate bridging agents. Direction emulsions may include a non-oleaginous continuous phase, an oleaginous discontinuous phase, and particular bridging agents. However, oil based fluids may also be formed from 100% oleaginous fluids in which the particulate bridging agents (as well as any other additives) may be dispersed.

The oleaginous fluid (forming any type of oil-based fluids) may be a liquid, more preferably a natural or synthetic oil, and more preferably the oleaginous fluid is selected from the group including diesel oil; mineral oil; a synthetic oil, such as hydrogenated and unhydrogenated olefins including polyalphaolefins, linear and branched olefins and the like, polydiorganosiloxanes, siloxanes, or organosiloxanes, esters of fatty acids, specifically straight chain, branched and cyclical alkyl ethers of fatty acids; similar compounds known to one of skill in the art; and mixtures thereof. For invert emulsions, the concentration of the oleaginous fluid should be sufficient so that an invert emulsion forms and may be less than about 99% by volume of the invert emulsion. In one embodiment, the amount of oleaginous fluid is from about 30% to about 95% by volume and more preferably about 40% to about 90% by volume of the invert emulsion fluid. The oleaginous fluid, in one embodiment, may include at least 5% by volume of a material selected from the group including esters, ethers, acetals, dialkylcarbonates, hydrocarbons, and combinations thereof.

The non-oleaginous fluid used in the formulation of the invert or direct emulsion fluid disclosed herein is a liquid and may be an aqueous liquid. In one embodiment, the non-oleaginous liquid may be selected from the group including sea water, a brine containing organic and/or inorganic dissolved salts, liquids containing water-miscible organic compounds, and combinations thereof. When forming an invert emulsion, the amount of the non-oleaginous fluid is typically less than the theoretical limit needed for forming an invert emulsion. Thus, in one embodiment, the amount of non-oleaginous fluid is less that about 70% by volume, and preferably from about 1% to about 70% by volume. In another embodiment, the non-oleaginous fluid is preferably from about 5% to about 60% by volume of the invert emulsion fluid.

Conventional methods can be used to prepare the wellbore fluids disclosed herein in a manner analogous to those normally used, to prepare conventional water- and oil-based wellbore fluids. In one embodiment, a desired quantity of water-based fluid and a suitable amount of one or more bridging agents, as described above, are mixed together and the remaining components of the wellbore fluid added sequentially with continuous mixing. In another embodiment, a desired quantity of oleaginous fluid such as a base oil, a non-oleaginous fluid, and a suitable amount of one or more bridging agents are mixed together and the remaining components are added sequentially with continuous mixing. An invert emulsion may be formed by vigorously agitating, mixing, or shearing the oleaginous fluid and the non-oleaginous fluid.

In yet another embodiment, the bridging agents of the present disclosure may be used alone or in combination with conventional solid bridging agents (e.g., calcium carbonates, etc.) Other additives that may be included in the wellbore fluids disclosed herein include, for example, wetting agents, organophilic clays, viscosifiers, fluid loss control agents, surfactants, dispersants, interfacial tension reducers, pH buffers, mutual solvents, thinners, thinning agents, and cleaning agents. The addition of such agents should be well known to one of ordinary skill in the art of formulating wellbore fluids and muds.

During a drilling process, the mud may be injected through the center of the drill string to the drill bit and exits in the annulus between the drill string and the wellbore, fulfilling, in this manner, the cooling and lubrication of the bit, casing of the well, and transporting the drill cuttings to the surface. During this process, some quantity of fluid may be filtrated into the subterranean formation through the side walls of the wellbore, so as to produce a filter cake of polymeric components and the particulate agents bridging numerous pores in the sidewalls of the wellbore.

When being used as a fluid loss pill, the viscous pill may be spotted or bullheaded into the appropriate location to reduce the rate of loss of a wellbore fluid to the formation through its viscosity or the viscous, bridging-solids-laden pill may be spotted or bullheaded into the appropriate location to reduce the rate of loss of a wellbore fluid to the formation by building a filtercake. Alternatively or in addition, various types of solids may optionally be suspended in wellbore fluids to bridge or block the holes of or gaps in a screen, thereby building a filtercake on the screen.

Breaking Filtercake

After completion of the drilling or completion process, the solid breaking agents may be released from the organic or inorganic encapsulation, such as by exposure of the encapsulation to a solubilizing wash (e.g., water, acid, oil, depending on the type of encapsulating material selected). The released breaking agents may then further contribute to the degradation and removal of the filtercake deposited on the sidewalls of the wellbore or on the gaps in a screen to minimize negatively impacting production.

A variety of methods for releasing the breaking agents from the organic or inorganic encapsulation may be applied, including a water (or undersaturated brine), acid, or oil wash. In one embodiment, an acid wash process may be applied. In this embodiment, for example, an acid solution, which is capable of at least partially breaking or dissolving the surface of the bridging particulate agent, may be injected into the wellbore to initiate the process of releasing the solid breaking agents from the encapsulation. For example, an acid solution, such as, for example, 5% hydrochloric acid or 10% citric acid, dissolves the encapsulant of acid-soluble material such as calcium carbonate, so as to allow the solid breaking agent to be released. Other chemicals, which are capable of dissolving the material of the encapsulant such as oxidants, enzymes, or chelants, may also be applied. Alternatively, for an oil-soluble encapsulating material, dissolution or degradation of the encapsulant may occur by hydrocarbons flowing out from the petroliferous formation or bullheaded down the well.

In another embodiment, a time delay process may be applied. In this embodiment, an imperfection in coating may allow diffusion of the core material. For example, wellbore fluid surrounding the bridging particles may diffuse through imperfections on the encapsulating layer into the core, and solubilize the core. The solubilized core, which may be acidic, may contribute to further solubilizing the coating and releasing the breaker. As a result, the fluid surrounding the bridging particle and the solubilized core contribute to solubilizing the coating from inside out. Those having ordinary skill in the art will recognize that a number of different methods for initiating the releasing process of the solid breaking agents from the inorganic encapsulation exist, and limitations on the present invention is not intended by reference to particular types.

Advantages of the present disclosure may include at least one of the following aspects. Conventionally, bridging agents and breaking agents are applied separately, for example, with a drilling fluid during drilling process, and a flushing fluid after the drilling process, respectively. One concern of filtercake breaking has always been to ensure that the components are adequately dissolved or otherwise removed from the wellbore wall or any remaining residue may negatively impact production. In contrast, in one or more embodiments of the present disclosure, use of particulate bridging agents having a breaker core and bridging encapsulant, in substitution for the two separate agents, may decrease the number of materials and processes required for drilling a wellbore as compared to the conventional method, thus simplifying the entire operation of drilling a wellbore. Further, due to the reduction of the required materials and operation processes, the present bridging agents may decrease the cost of the drilling operation. Moreover, use of the encapsulants disclosed herein may reduce the amount of materials left behind in the wellbore available to cause formation damage compared to conventional polymeric encapsulants (such as polyacrylates). Further, the agents may also have the compressive strength volumes comparable to conventional bridging agents.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A method of preventing fluid loss to a wellbore, comprising:
pumping a wellbore fluid into the wellbore through a subterranean formation, the wellbore fluid comprising:
a base fluid; and
a plurality of particulate bridging agents comprising a solid breaking agent encapsulated by one of an inorganic solid material and an oil-soluble resin; and
allowing some filtration of the wellbore fluid into the subterranean formation to produce a filter cake comprising the particulate bridging agents.

2. The method of claim 1, wherein the particulate bridging agents bridge pores of the formation when the particulate bridging agent is incorporated into the filter cake.

3. The method of claim 1, wherein the inorganic solid material comprises at least one of calcium carbonate, magnesium carbonate, magnesium oxide, sodium chloride, calcium chloride, zinc oxide, zinc carbonate, iron carbonate, iron oxide, calcium sulfate, strontium sulfate and barium sulfate.

4. The method of claim 1, wherein the solid breaking agent comprises at least one of an organic acid, an inorganic acid, a hydrolysable ester, a chelating agent, a scale dissolving agent, a solvent, a surfactant, a thinning agent, an oxidizing agent, and an enzyme.

5. A method of breaking a filtercake, comprising:
releasing a solid breaking agent encapsulated by one of a solid inorganic material and an oil-soluble resin from the encapsulation, wherein the encapsulated solid breaking agent is incorporated in the filtercake; and
allowing the released breaking agent to degrade at least a portion of the filtercake.

6. The method of claim 5, wherein the encapsulated solid breaking agent bridges pores of a wellbore wall.

7. The method of claim 5, wherein the inorganic solid material comprises at least one of calcium carbonate, magnesium carbonate, magnesium oxide, sodium chloride, calcium chloride, zinc oxide, zinc carbonate, iron carbonate, iron oxide, calcium sulfate, strontium sulfate and barium sulfate.

8. The method of claim 5, wherein the solid breaking agent comprises at least one of an organic acid, an inorganic acid, a hydrolysable ester, a chelating agent, a scale dissolving agent, a solvent, a surfactant, a thinning agent, an oxidizing agent, and an enzyme.

9. The method of claim 5, wherein the releasing comprises allowing the breaking agent to diffuse through the encapsulant.

10. The method of claim 5, wherein the releasing comprises dissolving the solid inorganic material by exposing to one of water, an acidic solution, an oxidant, a scale removal agent, and an oleaginous fluid.

11. A wellbore fluid comprising:
a base fluid; and
particulate bridging agents comprising a solid breaking agent encapsulated by one of a solid inorganic material and an oil-soluble resin.

12. The fluid of claim 11, wherein the inorganic solid material comprises at least one of calcium carbonate, magnesium carbonate, magnesium oxide, sodium chloride, calcium chloride, zinc oxide, zinc carbonate, iron carbonate, iron oxide, calcium sulfate, strontium sulfate and barium sulfate.

13. The fluid of claim 11, wherein the solid breaking agent comprises at least one of an organic acid, an inorganic acid, a hydrolysable ester, a chelating agent, a scale dissolving agent, a solvent, a surfactant, a thinning agent, an oxidizing agent, and an enzyme.

14. A particulate bridging agent used for forming and breaking a filtercake on a wellbore wall, comprising:
a solid breaking agent encapsulated by one of a solid inorganic material and an oil-soluble resin.

15. The particulate bridging agent of claim 14, wherein the second solid material comprises one of an organic and inorganic solid material.

16. The particulate bridging agent of claim 14, wherein the inorganic solid material comprises at least one of calcium carbonate, magnesium carbonate, magnesium oxide, sodium chloride, calcium chloride, zinc oxide, zinc carbonate, iron carbonate, iron oxide, calcium sulfate, strontium sulfate and barium sulfate.

17. The particulate bridging agent of claim 14, wherein the solid breaking agent comprises at least one of an organic acid, an inorganic acid, a hydrolysable ester, a chelating agent, a scale dissolving agent, a solvent, a surfactant, a thinning agent, an oxidizing agent, and an enzyme.

18. A method of forming a particle comprising:
providing a solid breaking agent; and
encapsulating the solid breaking agent with one of a solid inorganic material and an oil-soluble resin.

19. The method of claim 18, wherein the inorganic solid material comprises at least one of calcium carbonate, magnesium carbonate, magnesium oxide, sodium chloride, calcium chloride, zinc oxide, zinc carbonate, iron carbonate, iron oxide, calcium sulfate, strontium sulfate and barium sulfate.

20. The method of claim 18, wherein the solid breaking agent comprises at least one of an organic acid, an inorganic acid, a hydrolysable ester, a chelating agent, a scale dissolving agent, a solvent, a surfactant, a thinning agent, an oxidizing agent, and an enzyme.

21. The method of claim 18, wherein the encapsulating comprises spray drying the solid breaking agent with one of the solid inorganic material and the oil-soluble resin.

22. The method of claim 18, wherein the encapsulating comprises using a fluidized bed.
